(19) United States
(12) Patent Application Publication
(10) Pub. No.: US 2023/0310257 A1
(43) Pub. Date: Oct. 5, 2023

(54) COMPRESSION AND HEAT THERAPY DEVICE AND METHOD OF USE

(71) Applicant: REATHLETE LLC, Tallahassee, FL (US)

(72) Inventor: Ziv LEVY, Moshev Ora (IL)

(21) Appl. No.: 17/714,086

(22) Filed: Apr. 5, 2022

(51) Int. Cl. A61H 9/00

(52) U.S. Cl. CPC A61H 9/0092; A61H 2201/165; A61H 2201/164; A61H 2201/0207; A61H 2201/5007; A61H 2201/5043; A61H 2201/5025; A61H 2205/102; A61H 2205/106; A61H 2205/108; A61H 2201/0157

(57) ABSTRACT

A compression device wearable by a user can be used to apply compression on one of a left lower limb or a right lower limb of the user. The compression device includes a massager sleeve, a computing device, and an air pressure hose. The massager sleeve is adapted to surround and secure one of the left lower limb or the right lower limb. The massager sleeve includes a heat pad to apply heat to the left knee or the right knee of the user. The computing device generates air pressure. The computing device includes a control panel to control the flow of the air pressure in the massager sleeve. The computing device includes a battery to provide power supply to the control panel. The air pressure hose supplies air pressure to the massager sleeve.

### FIELD OF THE INVENTION

The present invention relates to a compression device, and more particularly to a rechargeable and portable compression device wearable by a user for applying compression on one of a left lower limb or a right lower limb and heat on a corresponding knee of the user.

### BACKGROUND

Typically, compression devices or clothes for applying compression to a selected area of a user's anatomy are used in many situations. For example, compression devices are used to treat venous insufficiency or edema, or to recover muscle or to provide improved blood flow, or to prevent deep vein thrombosis (DVT). Such a compression device according to the preamble is also known from the U.S. Pat. No. 10,772,790B2 issued to Wild, et al.

Wild, et al. further describe a compression device for the limb of a mobile patient. The device includes an inflatable sleeve adapted to surround the limb; a conduit attached to the sleeve for delivering fluid to the sleeve; and a portable, wearable controller attached to the conduit that generates and controls the flow of fluid in the device.

Also known is an apparatus for providing compression and vibration therapy from US patent US20210275390A1 filed by Hsueh; Yu-Chi; et al. Hsueh; Yu-Chi; et al. discloses an apparatus for providing compression and vibration therapy to a body part and can include a housing, a pump positioned in the housing, the pump configured to generate air pressure, a compression sleeve configured to at least partially surround the body part, the compression sleeve can include an inflatable chamber in fluid communication with the pump and can be configured to apply pressure to the body part in response to receiving air from the pump, and a vibrating unit configured to apply vibration to the body part.

US patent US20210275386A1 filed by Ravikumar; Sundaram; et al. describes a therapeutic compression apparatus for providing pressure to a limb or other body part including a bladder assembly having at least one bladder within a primary wrap and/or a secondary wrap. The primary wrap includes an inflation port to connect to an inflation means which provides either constant or varying pressure within the bladder and a check valve is included in the inflation port and/or inflation means.

These known devices do not have hot and cold features and various compression modes. Further, the existing compression devices have various disadvantages such as the sleeves being inflatable and not user-friendly. The sleeves are wrapped around the limb and the bladder are inflated by a controller that resides separately from the user. If the user must move, the sleeve must be removed. In addition, while the sleeve is on the user, the tubes connecting the bladder and controller may become entangled with the user's limbs.

The present invention aims to resolve at least some of the problems and disadvantages mentioned above. The aim of the invention is to provide a compression device and method that eliminates those disadvantages. The present invention targets at solving at least one of the aforementioned disadvantages.

The invention thereto aims to provide a compression device wearable by a user for applying compression on one of a left lower limb or a right lower limb and heat on a corresponding knee of the user.

There remains a need in the art for an improved and portable compression device.

Accordingly, a need arises for a portable air compression massager and heat therapy device to alleviate pain and accelerate recovery.

### SUMMARY OF THE INVENTION

The present invention and embodiments thereof serve to provide a solution to one or more of the above-mentioned disadvantages. To this end, the present invention relates to a compression device wearable by a user for applying compression on one of a left lower limb or a right lower limb and heat on a corresponding knee of the user. According to an embodiment herein, the compression device includes a massager sleeve, a computing device, and an air pressure hose. The massager sleeve is adapted to surround one of the left lower limb or the right lower limb. The massager sleeve includes a first plurality of hook and loop fasteners to secure calf and knee or thigh and knee of one of the left lower limb or the right lower limb of the user. The massager sleeve includes a heat pad to apply heat to one of the left knee or the right knee of the user. The computing device is adapted to generate air pressure. The computing device is directly attached to the massager sleeve. The computing device includes a control panel and a battery. The control panel is adapted to control the flow of the air pressure in the massager sleeve. The battery is adapted to provide power supply to the control panel, wherein the battery is operably connected to the control panel to provide usage of the compression device without being connected with a power supply. The air pressure hose supplies air pressure to the massager sleeve in response to receiving air pressure from the computing device. The air pressure hose is directly attached to the massager sleeve to apply the air pressure to one of the left lower limb or the right lower limb.

In another embodiment, the massager sleeve is adapted to secure either the calf and knee or the thigh and knee depending upon usages of the compression device.

In another embodiment, the computing device includes a display screen to display a timer, a compression intensity, a heat intensity, a battery status, and a plurality of massage modes.

In another embodiment, the battery status indicates a battery level of remaining power available in the battery.

In another embodiment, the computing device comprises a timer button to set the timer of usage to the compression device upon receiving a press gesture from the user.

In another embodiment, the computing device includes an intensity button to start and stop an operation of the computing device and to adjust one or more air pressure levels upon receiving a press gesture from the user.

In another embodiment, the computing device includes a first massage mode button to initiate a first command pertaining to simultaneously massage the knee and calf/thigh of the user upon receiving a press gesture from the user.

In another embodiment, the computing device includes a second massage mode button to initiate a second command pertaining to massage at least the calf/thigh of the user upon receiving a press gesture from the user.

In another embodiment, the computing device includes a third massage mode button to initiate a third command pertaining to massage the knee of the user upon receiving a press gesture from the user.

In another embodiment, the computing device comprises a heat mode button to initiate a fourth command pertaining to adjusting one or more heating levels.

In another embodiment, the computing device includes a memory to store a plurality of instructions pertaining to the one or more air pressure levels, the first command, the second command, the third command, the fourth command, the one or more heating levels, and the battery levels; and a processor to execute the plurality of instructions stored in the memory.

In another embodiment, the air pressure hose is inserted into the computing device to supply the air pressure, and wherein the computing device is present directly on the massager sleeve.

In another embodiment, the compression device includes an AC adapter and an extension cord to charge the battery of the computing device.

In another embodiment, the compression device is placed in a carry bag to provide portability when the compression device is not in use.

In a second aspect, the present invention relates to a method for applying compression on one of a left lower limb or a right lower limb and heat on one of a left knee or a right knee of the user. The method includes a step of providing power supply to a computing device using a battery. The method includes generating air pressure using the computing device. The method includes a step of controlling the air pressure through a control panel of the computing device. The method includes a step of supplying air pressure using an air pressure hose to a massager sleeve in response to receiving air pressure from the computing device. The method includes a step of surrounding one of the left lower limb or the right lower limb by a massager sleeve and applying air pressure to one of the left lower limb or the right lower limb. The massager sleeve includes a heat pad. The method further includes applying heat to one of the left knee or the right knee using the heat pad. The method includes a step of wearing the massager sleeve to secure either the calf and the knee or the thigh and the knee depending upon the usage. The method includes a step of displaying a timer, a compression intensity, a heat intensity, a battery status, and a plurality of massage modes through a display screen configured within the computing device. The method includes a step of starting and stopping an operation of the computing device and adjusting one or more air pressure levels upon receiving a press gesture from the user through an intensity button present on the computing device.

In another embodiment, the one or more air pressure levels having a predefined pressure value stored in a memory of the computing device.

In another embodiment, the one or more air pressure levels comprises a first air pressure level, a second air pressure level, a third air pressure level, and a fourth air pressure level.

In another embodiment, the predefined Pulse Width Modulation (PWM) for the first air pressure level is about 70 percent.

In another embodiment, the predefined PWM for the second air pressure level is about 85 percent.

In another embodiment, the predefined PWM for the third air pressure level is about 100 percent.

In another embodiment, the one or more heating levels having a predefined heat value stored in the memory of the computing device.

In another embodiment, the one or more heating levels comprises a first heating level, a second heating level, and a third heating level.

In another embodiment, the predefined heat value for the first heating level is about 49.7 degrees Celsius.

In another embodiment, the predefined heat value for the second heating level is about 59.7 degrees Celsius.

In another embodiment, the predefined heat value for the third heating level is about 60.8 degrees Celsius.

The method includes the step of charging the battery using an adapter and an extension cord. The method includes the step of plugging a first end of the adapter into a power outlet and a second end of the adapter into a charging port of the control unit to charge the battery.

### DESCRIPTION OF FIGURES

The following description of the figures of specific embodiments of the invention is merely exemplary in nature and is not intended to limit the present teachings, their application, or their uses. Throughout the drawings, corresponding reference numerals indicate like or corresponding parts and features.

FIG. 1 shows a schematic representation of a compression device wearable by a user for applying compression on one of a left lower limb or a right lower limb of the user of an embodiment of the present invention.

FIG. 2 shows a first schematic front view of the massager sleeve of an embodiment of the present invention.

FIG. 3 shows a first schematic rear view of the massager sleeve of an embodiment of the present invention.

FIG. 4 shows a second schematic front view of the massager sleeve of an embodiment of the present invention.

FIG. 5 shows a schematic top view of the massager sleeve of an embodiment of the present invention.

FIG. 6 shows a first schematic side view of the massager sleeve of an embodiment of the present invention.

FIG. 7 shows a schematic view of hook and loop fasteners of the massager sleeve of an embodiment of the present invention.

FIG. 8 shows a second schematic side view of the massager sleeve of an embodiment of the present invention.

FIG. 9 shows a third schematic side view of the massager sleeve of an embodiment of the present invention.

FIG. 10 shows a second schematic rear view of the massager sleeve of an embodiment of the present invention.

FIG. 11 shows a schematic front view of the massager sleeve with the computing device of an embodiment of the present invention.

FIG. 12 shows a schematic view of the computing device of an embodiment of the present invention.

FIG. 13 shows an exploded view of the computing device of an embodiment of the present invention.

FIG. 14 shows a flowchart of a method for applying compression on one of a left lower limb or a right lower limb of the user of an embodiment of the present invention.

### DETAILED DESCRIPTION OF THE INVENTION

The present invention concerns a compression device wearable by a user for applying compression on one of a left lower limb or a right lower limb and heat on a corresponding knee of the user.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7, etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention and form different embodiments, as would be understood by those in the art. For example, in the following claims, any of the claimed embodiments can be used in any combination.

In a first aspect, the invention provides/relates to a compression device wearable by a user for applying compression on one of a left lower limb or a right lower limb of the user. The compression device includes a massager sleeve, a computing device, and an air pressure hose. The computing device includes a control unit and a battery.

The inventors have unexpectedly observed that the present invention provides a portable professional-grade air compression massager with 3 modes and 1 airbag with 2 divisions to provide muscle recovery, pain relief, decrease inflammation, better blood flow, and ensure a thorough relaxation experience. Further, the compression device of the present invention provides a massage to calf and knee or thigh and knee of the user depending upon the usage of the compression device. For example, the user may wear the compression device in first way to massage the calf and knee of the user. Alternately, the user may wear the compression device in second way to massage the thigh and knee of the user. Further, the compression device can be used on any one of the lower limbs according to requirement. Furthermore, the compression device of the present invention provides flexibility to the user to use the compression device without continuous plugged in into the power supply.

In a preferred embodiment of the invention, the computing device includes a battery attached with the computing device to supply power to the computing device without external power supply.

In a particularly preferred embodiment, the computing device has various configurations to enable the user to find a massage mode that fits the user best.

In another preferred embodiment, the massager sleeve includes adjustable fasteners to ensure that the sleeves fit the users irrespective of their limb's size.

However, it is obvious that the invention is not limited to this application. The method according to the invention can be applied in all sorts of wearable compression devices, massager, and rechargeable therapy devices.

The invention is further described by the following non-limiting examples which further illustrate the invention, and are not intended to, nor should they be interpreted to, limit the scope of the invention.

The present invention will be now described in more detail, referring to examples that are not limitative.

### Examples and/or Description of Figures

With as a goal illustrating better the properties of the invention the following presents, as an example and limiting in no way other potential applications, a description of a number of preferred applications of the method for examining the state of the grout used in a mechanical connection based on the invention, wherein:

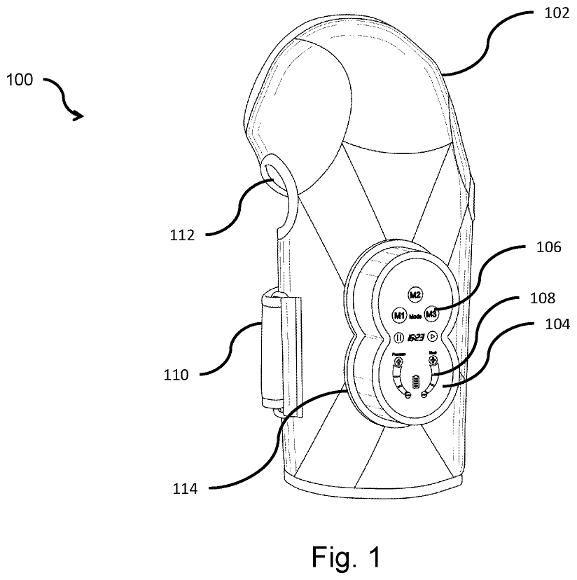

FIG. 1 shows a schematic representation of a compression device 100 wearable by a user for applying compression on one of a left lower limb or a right lower limb of the user of an embodiment of the present invention. The compression device 100 includes a massager sleeve 102, a computing device 104, an air pressure hose 114. The massager sleeve 102 is adapted to surround one of the left lower limb or the right lower limb according to the usages. The computing device 104 generates air pressure. The air pressure hose 114 supplies air pressure to the massager sleeve 102 in response to receiving air pressure from the computing device 104. The air pressure hose 114 is inserted between the computing device 104 and to the massager sleeve 102 to apply the air pressure to one of the left lower limb or the right lower limb. The massager sleeve 102 includes a first hook and loop fastener 112 to secure the thigh or the calf of the user according to the usage. The massager sleeve 102 further includes a second hook and loop fastener 110 to secure the thigh or the calf of the user according to the usage. The first hook and loop fasteners 112 and the second hook and loop fasteners 110 are adjustable fasteners to ensure that the massager sleeve 102 fit the users irrespective of their size. The computing device 104 includes control panel 106 and a display screen 108. The control panel 106 controls the flow of the air pressure. the display screen 108 display a timer, a compression intensity, a heat intensity, a battery status, and a plurality of massage modes. Further, the massager sleeve 102 comprises a heat pad (not illustrated) to apply heat to the left knee or the right knee of the user. In another embodiment, the compression device 100 includes an adapter and an extension cord to recharge the computing device 104. In another embodiment, the compression device 100 is placed in a carry bag when not in use to provide portability.

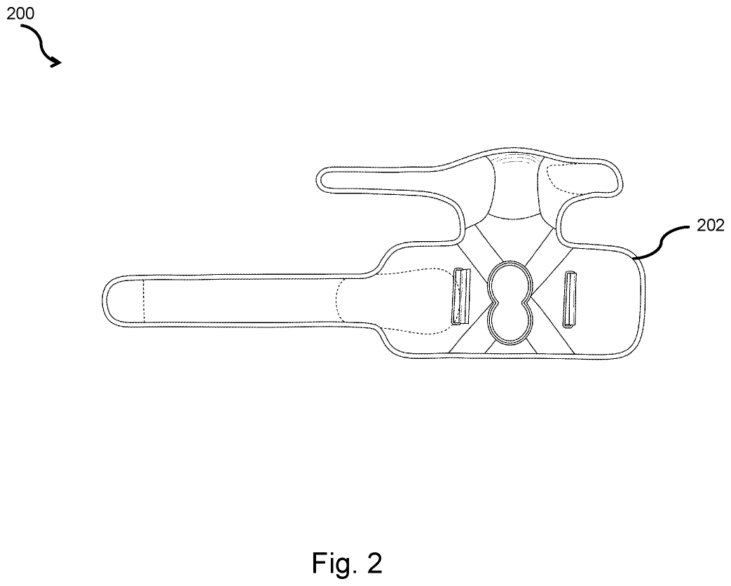

FIG. 2 shows a first schematic front view 200 of the massager sleeve of an embodiment of the present invention. According to an embodiment herein, the compression device includes a massager sleeve 202 to surround one of the left lower limb or the right lower limb of the user. FIG. 2 illustrates the front view of the massager sleeve 202 when the compression device is open and not in use.

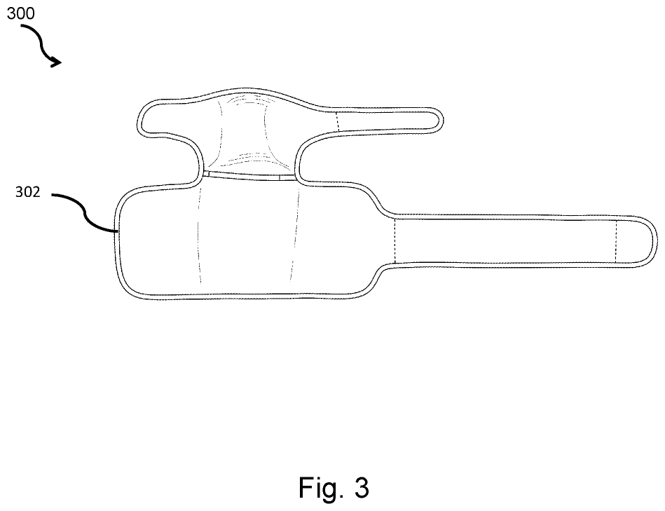

FIG. 3 shows a first schematic rear view 300 of the massager sleeve of an embodiment of the present invention. According to an embodiment herein, the compression device includes a massager sleeve 302 to surround one of the left lower limb or the right lower limb of the user. FIG. 3 illustrates the rear view of the massager sleeve 302 when the compression device is open and not in use.

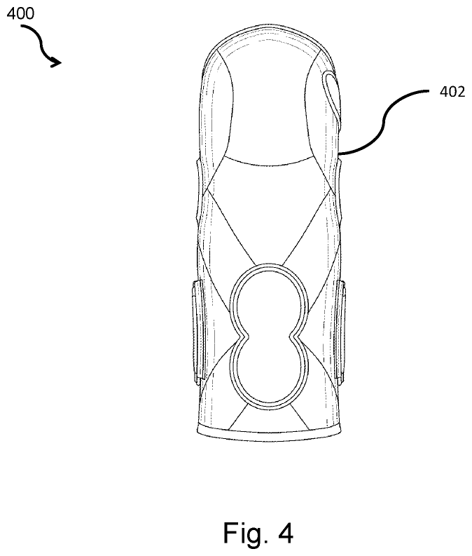

FIG. 4 shows a second schematic front view 400 of the massager sleeve of an embodiment of the present invention. According to an embodiment herein, the compression device includes a massager sleeve 402 to surround one of the left lower limb or the right lower limb of the user. FIG. 4 illustrates the front view of the massager sleeve 402 when the user wears the compression device.

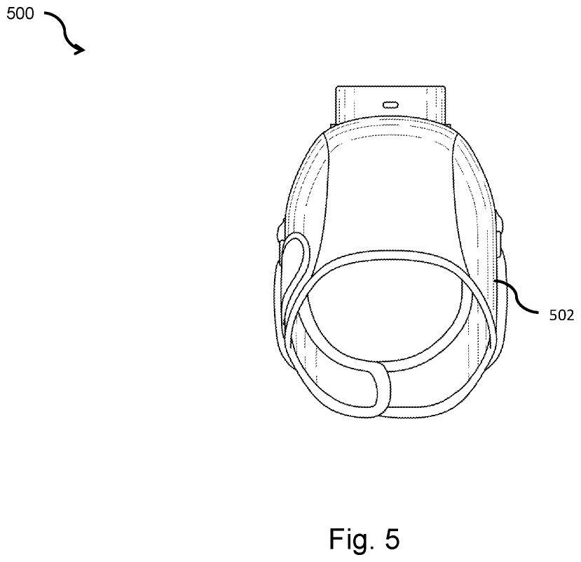

FIG. 5 shows a schematic top view 500 of the massager sleeve of an embodiment of the present invention. In an embodiment, the massager sleeve 502 covers the knee and the calf of the user when the user uses the compression device to massage the calf and the knee. In another embodiment, the massager sleeve 502 covers the knee and the thigh of the user when the user uses the compression device to massage the thigh and the knee.

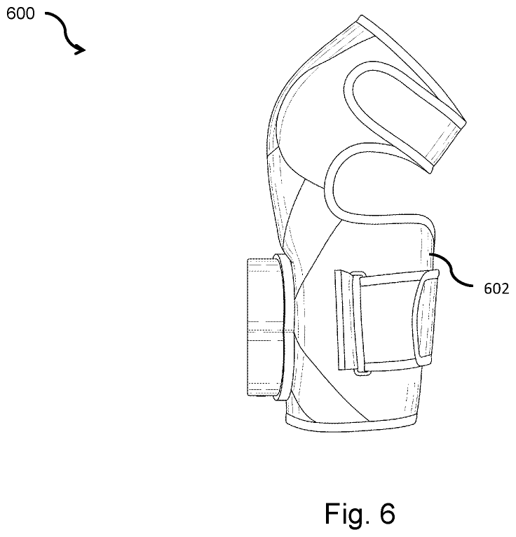

FIG. 6 shows a first schematic side view 600 of the massager sleeve of an embodiment of the present invention. In an embodiment, the massager sleeve 602 provides full cover to the knee and the calf of the user when the user uses the compression device to massage the calf and the knee. In another embodiment, the massager sleeve 502 provides full cover to the knee and the thigh of the user when the user uses the compression device to massage the thigh and the knee. Thus, the compression device will gently help the user to rest and recover at the end of a long day.

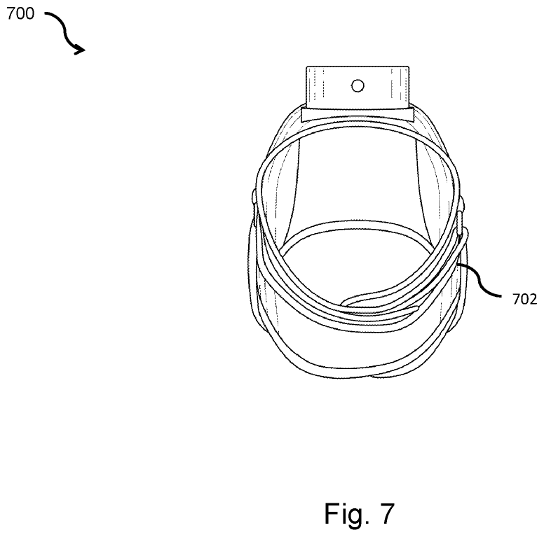

FIG. 7 shows a schematic view 700 of hook and loop fasteners of the massager sleeve of an embodiment of the present invention. According to an embodiment herein, the loop and fasteners 702 is adjustable to easily fit the massager sleeve into the users of any size.

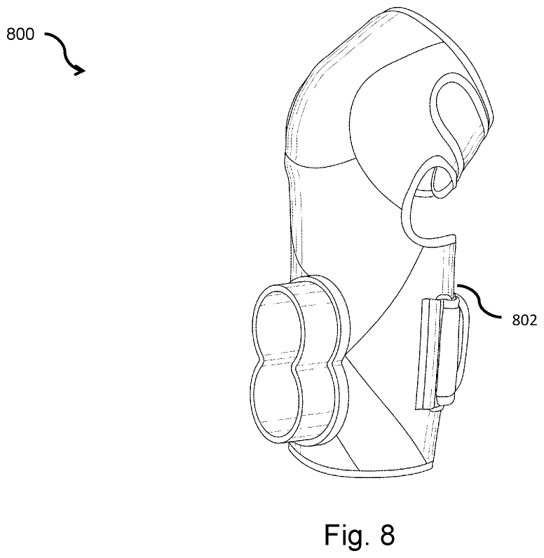

FIG. 8 shows a second schematic side view 800 of the massager sleeve of an embodiment of the present invention. In an embodiment, the massager sleeve 802 provides full cover to the knee and the calf of the user when the user uses the compression device to massage the calf and the knee. In another embodiment, the massager sleeve 802 provides full cover to the knee and the thigh of the user when the user uses the compression device to massage the thigh and the knee. Thus, the compression device will gently help the user to rest and recover at the end of a long day.

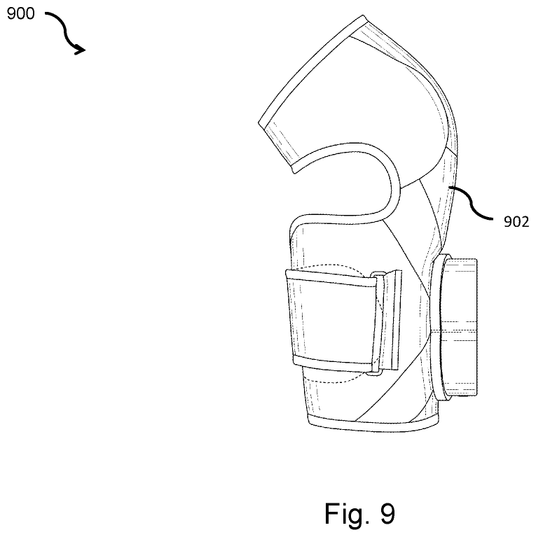

FIG. 9 shows a third schematic side view 900 of the massager sleeve of an embodiment of the present invention. In an embodiment, the massager sleeve 902 provides full cover to the knee and the calf of the user when the user uses the compression device to massage the calf and the knee. In another embodiment, the massager sleeve 902 provides full cover to the knee and the thigh of the user when the user uses the compression device to massage the thigh and the knee. Thus, the compression device will gently help the user to rest and recover at the end of a long day.

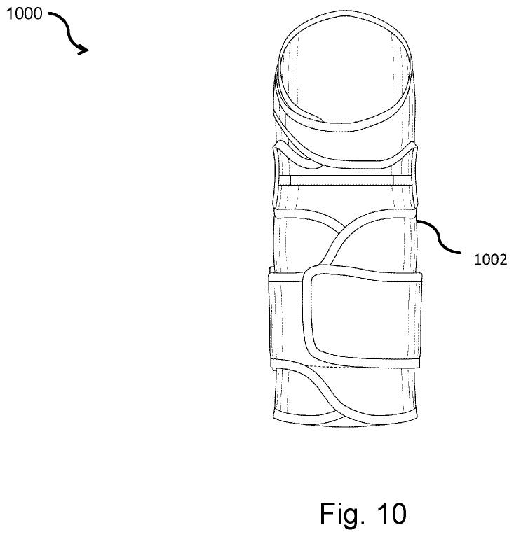

FIG. 10 shows a second schematic rear view 1000 of the massager sleeve of an embodiment of the present invention. According to an embodiment herein, the compression device includes a massager sleeve 1002 to surround one of the left lower limb or the right lower limb of the user. FIG. 10 illustrates the rear view of the massager sleeve 1002 when the user wears the compression device.

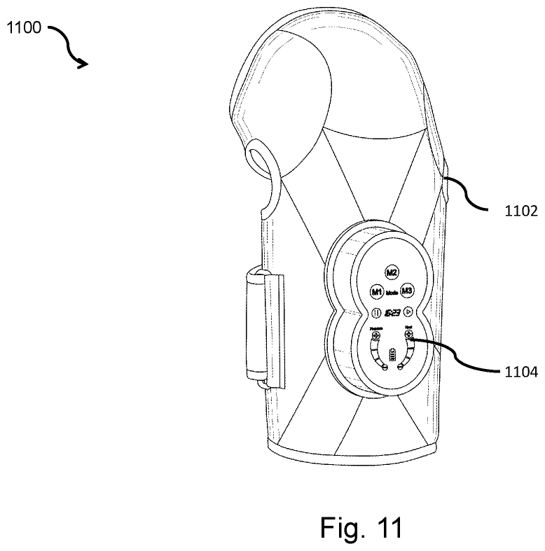

FIG. 11 shows a schematic front view 1100 of the massager sleeve with the computing device of an embodiment of the present invention. According to an embodiment herein, the compression device includes a massager sleeve 1102 and the computing device 1104. The computing device 1104 is directly attached to the massager sleeve 1102 to provide air compression to one of the left lower limb or the right lower limb according to the usages.

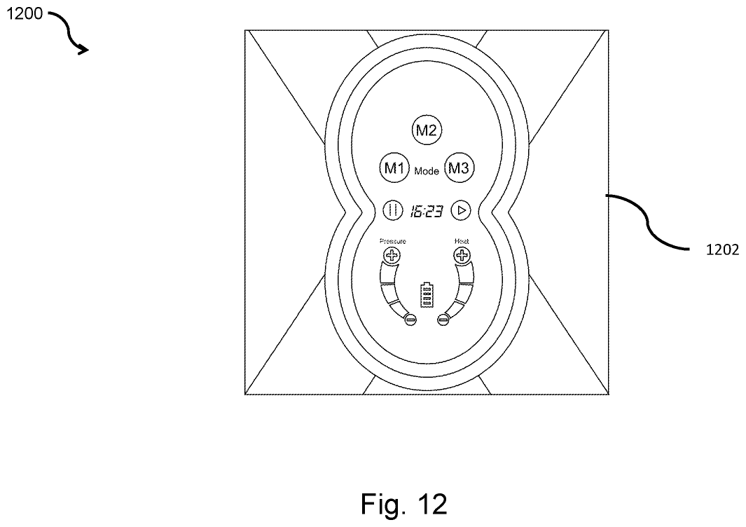

FIG. 12 shows a schematic view 1200 of the computing device of an embodiment of the present invention. According to an embodiment herein, the compression device includes the computing device 1202.

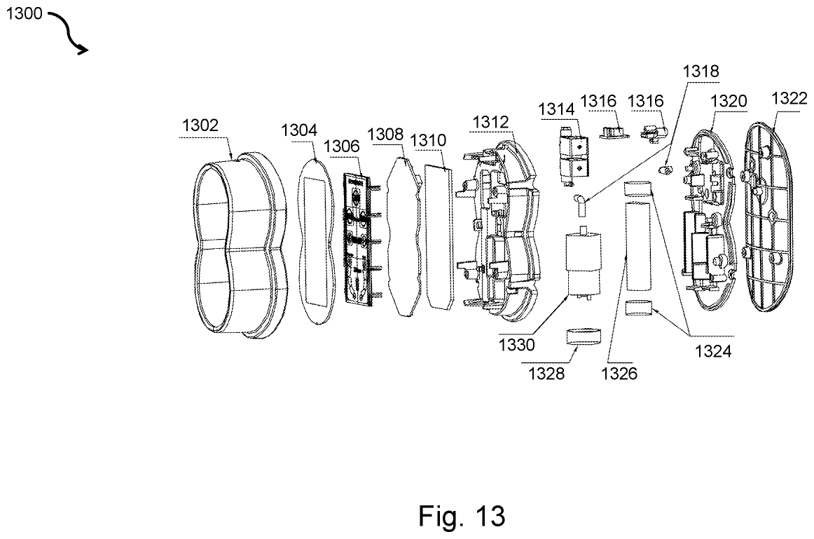

FIG. 13 shows an exploded view 1300 of the computing device of an embodiment of the present invention. FIG. 13 is explained in conjunction with FIG. 1. According to an embodiment herein, the computing device 104 includes various components such as Upper cover of controller 1302, a Glass 1304, LCD 1306, Circuit board 1308, Backlight 1310, Central cover of controller 1312, Two lines of air valves 1314, Charging board and USB board 1316, Silicon elbow pipe of air valve 1318, Lower cover of controller 1320, Platen 1322, Cushion-2 1324, Battery 1326, Cushion-1 1328, and Air pump 1330. According to an embodiment herein, the Upper cover of controller 1302 is made of ABS, Glass 1304 is made of PMMA, the display is an LCD 1306 screen made of glass, the Circuit board 1308 is made of PCBA, the Central cover of controller 1312 is made of ABS, the lines of air valves 1314 is made of Cold rolled sheet+free-machining steel+Nylon plus glass fiber, the Charging board is made of PCBA, the USB board is made of ABS, the Lower cover of controller 1320 is made of ABS, the Platen 1322 is made of ABS, the Cushion-1 1328 and Cushion-2 1324 is made of EVA, and Air pump 1330 is made of Cold rolled sheet+free-machining steel+copper wire+POM+Rubber. In an embodiment, the airbag is made of TPU and Nylon 210D. The sleeve cover is made of Black 200D Nylon (polyamide).

The computing device 104 includes a control panel 106 to control the flow of the air pressure in the massager sleeve 102. In another embodiment, the computing device 106 includes a display screen 122 to display a timer, a compression intensity, a heat intensity, a battery status, and a plurality of massage modes such as a first massage mode (Mode 1), second massage mode (Mode 2), and the third massage mode (Mode 3). The following table 1 depicts the working part of the body in various massage modes.

TABLE 1

Key working part

| Mode | Knee | Calf/thigh |
|---|---|---|
| Mode1 | 1 | 1 |
| Mode2 | | 1 |
| Mode3 | 1 | |

The first massage mode button initiates a first command pertaining to simultaneously massage the knee and calf/thigh of the user upon receiving a press gesture from the user. The second massage mode button initiates a second command pertaining to massage at least the calf/thigh of the user upon receiving a press gesture from the user. The third massage mode button initiates a third command pertaining to massage the knee of the user upon receiving a press gesture from the user. The intensity button starts and stops an operation of the computing device and adjusts one or more air pressure levels upon receiving a press gesture from the user. In an embodiment, the user can press the intensity button to adjust the intensity (from Level 1 to Level 4). Further, the user can press the intensity button for at least 3 seconds to turn off the operation of the computing device. The following table 2 depicts the PWM duty ratio for air pump for each level.

TABLE 2
PWM duty ratio for air pump

| | |
|---|---|
| Level 1 | 70% |
| level 2 | 85% |
| Level 3 | 100% |

There is no absolute correspondence between the air pressure value of each air bag and the time during the working process; the program only controls the air pressure value of the key control node, and the air pressure value during the inflation process is not used as a control parameter.

Further, the heat mode button initiates a fourth command pertaining to adjusting one or more heating levels such as level 1 and level 2. In an embodiment, the massage modes, compression intensity, and heat intensity are controlled independently. Furthermore, the user can press the heat mode button to cycle through various heat modes such as OFF, low, and high heat modes. For the safety of the user, the present compressor device will automatically shut down after 30 minutes of continuous use. The following table 3 depicts the preset temperature value for each heating level.

TABLE 3
The set temperature value for each level

| | |
|---|---|
| Level 1 | 49.7° C. |
| Level 2 | 59.7° C. |
| Level 3 | 60.8° C. |

Deviation: ±4° C.
The product only controls the maximum heating temperature; when the temperature is lower than the maximum temperature, the heating temperature increases with time, and the overall trend is upward. The increase conditions of heating temperature changes with the change of heat dissipation conditions, and there is no absolute correspondence between the heating temperature and the working time during the working process of the product.

The computing device 106 includes a memory to store a plurality of instructions pertaining to the one or more air pressure levels, the first command, the second command, the third command, the fourth command, and the one or more heating levels, and control parameter. Further, the computing device includes a processor to execute the plurality of instructions or software programs stored in the memory. The instructions related to each massage mode are stored in the memory and executed by the processor as per the fowling tables 4-6 upon receiving the press gesture from the user.

TABLE 4
Mode1

| Step | Time (S) | Knee | Calf/thigh |
|---|---|---|---|
| 1 | 10 | C | C |
| 2 | 1 | R | |
| 3 | 3 | R | R |
| 4 | 2 | | R |
| 5 | 10 | | C |
| 6 | 3 | | R |
| 7 | 3 | R | R |
| 8 | 2 | R | |
| 9 | 10 | C | |
| 10 | 3 | R | |
| 11 | 3 | R | R |
| 12 | 2 | | R |
| 13 | 10 | | C |
| 14 | 3 | | R |
| 15 | 3 | R | R |
| 16 | 2 | R | |
| 17 | 10 | | C |
| 18 | 0.5 | C | |
| 19 | 10 | C | C |
| 20 | 0.5 | C | |
| 21 | 7 | C | C |
| 22 | 10 | R | R |
| 23 | 10 | | C |
| 24 | 1 | R | |
| 25 | 10 | C | C |
| 26 | 1 | | R |
| 27 | 10 | C | C |
| 28 | 0.5 | | R |
| 29 | 5 | R | R |
| 30 | 0.5 | R | |
| 31 | 10 | | C |
| 32 | 8 | | R |
| 33 | 2 | R | R |
| 34 | 10 | C | |
| 35 | 8 | R | |
| 36 | 2 | R | R |
| 37 | 9 | C | C |
| 38 | 0.5 | | R |
| 39 | 6 | C | C |
| 40 | 0.5 | | R |
| 41 | 6 | C | C |
| 42 | 0.5 | | R |
| 43 | 6 | C | C |
| 44 | 0.5 | R | |
| 45 | 6 | C | C |
| 46 | 0.5 | R | |
| 47 | 6 | C | C |
| 48 | 0.5 | R | |
| 49 | 6 | C | C |
| 50 | 10 | R | R |
| 51 | 0.5 | | |
| 52 | 8 | C | C |
| 53 | 0.5 | | |
| 54 | 8 | C | C |
| 55 | 0.5 | | |
| 56 | 8 | C | C |
| 57 | 8 | | C |
| 58 | 15 | C | |
| 59 | 5 | R | |
| 60 | 10 | C | |
| 61 | 3 | R | |
| 62 | 2 | R | R |
| 63 | 12 | | C |
| 64 | 5 | | R |
| 65 | 10 | | C |
| 66 | 3 | | R |
| 67 | 2 | R | R |
| 68 | 12 | C | |
| 69 | 1.5 | R | R |
| 70 | 1 | | R |
| 71 | 12 | | C |
| 72 | 5 | | R |
| 73 | 2 | R | R |
| 74 | 14 | C | |
| 75 | 5 | R | |
| 76 | 2 | R | R |
| 77 | 15 | C | C |
| 78 | 10 | R | R |
| 79 | 10 | C | C |
| 80 | 0.5 | R | |
| 81 | 3 | R | R |
| 82 | 0.5 | | R |
| 83 | 3 | R | R |
| 84 | 8 | C | C |
| 85 | 4 | R | R |
| 86 | 4 | | R |
| 87 | 4 | R | |
| 88 | 10 | C | |
| 89 | 0.5 | | |
| 90 | 10 | C | |
| 91 | 2 | R | R |
| 92 | 10 | | C |
| 93 | 0.5 | | |
| 94 | 10 | | C |
| 95 | 3 | | |

TABLE 5
Mode2

| Step | Time (S) | Knee | Calf/thigh |
|---|---|---|---|
| 1 | 10 | | C |
| 2 | 3 | | R |
| 3 | 3 | R | R |
| 4 | 10 | | C |
| 5 | 3 | | R |
| 6 | 5 | R | R |
| 7 | 1 | R | |
| 8 | 5 | R | R |
| 9 | 5 | | C |
| 10 | 0.5 | R | R |
| 11 | 5 | | C |
| 12 | 0.5 | R | R |
| 13 | 5 | | C |
| 14 | 2 | R | R |
| 15 | 0.5 | R | |
| 16 | 5 | R | R |
| 17 | 1 | R | |
| 18 | 10 | C | C |
| 19 | 0.5 | | |
| 20 | 8 | | C |
| 21 | 0.5 | | |
| 22 | 5 | | C |
| 23 | 0.5 | | |
| 24 | 3 | | C |
| 25 | 3 | R | R |
| 26 | 0.5 | R | |
| 27 | 3 | R | R |
| 28 | 0.5 | R | |
| 29 | 3 | R | R |
| 30 | 5 | | C |
| 31 | 5 | | R |
| 32 | 5 | R | R |
| 33 | 0.5 | R | |
| 34 | 8 | | C |
| 35 | 1 | R | |
| 36 | 3 | | C |
| 37 | 1 | | R |
| 38 | 8 | | C |
| 39 | 0.5 | R | |
| 40 | 8 | | C |
| 41 | 1 | R | R |
| 42 | 8 | C | C |
| 43 | 1 | R | R |
| 44 | 8 | | C |
| 45 | 5 | | R |
| 46 | 0.5 | R | R |
| 47 | 5 | | R |
| 48 | 1 | R | R |
| 49 | 5 | | C |
| 50 | 3 | | R |
| 51 | 2 | R | R |
| 52 | 10 | | 1 |
| 53 | 3 | | R |
| 54 | 2 | R | R |
| 55 | 10 | C | C |
| 56 | 0.5 | | R |
| 57 | 3 | R | R |
| 58 | 5 | | C |
| 59 | 0.5 | | |
| 60 | 5 | | C |
| 61 | 2 | | R |
| 62 | 3 | | |

TABLE 6
Mode3

| Step | Time (S) | Knee | Calf/thigh |
|---|---|---|---|
| 1 | 10 | C | |
| 2 | 3 | R | |
| 3 | 3 | R | R |
| 4 | 10 | C | |
| 5 | 3 | R | |
| 6 | 5 | R | R |
| 7 | 1 | | R |
| 8 | 5 | R | R |
| 9 | 5 | C | |
| 10 | 0.5 | R | R |
| 11 | 5 | C | |
| 12 | 0.5 | R | R |
| 13 | 5 | C | |
| 14 | 2 | R | R |
| 15 | 0.5 | | R |
| 16 | 5 | R | R |
| 17 | 1 | | R |
| 18 | 10 | C | C |
| 19 | 0.5 | | |
| 20 | 8 | C | |
| 21 | 0.5 | | |
| 22 | 5 | C | |
| 23 | 0.5 | | |
| 24 | 3 | C | |
| 25 | 3 | R | R |
| 26 | 0.5 | | R |
| 27 | 3 | R | R |
| 28 | 0.5 | | R |
| 29 | 3 | R | R |
| 30 | 5 | C | |
| 31 | 5 | R | |
| 32 | 5 | R | R |
| 33 | 0.5 | | R |
| 34 | 8 | C | |
| 35 | 1 | | R |
| 36 | 3 | C | |
| 37 | 1 | R | |
| 38 | 8 | C | |
| 39 | 0.5 | | R |
| 40 | 8 | C | |
| 41 | 1 | R | R |
| 42 | 8 | C | C |
| 43 | 1 | R | R |
| 44 | 8 | C | |
| 45 | 5 | R | |
| 46 | 0.5 | R | R |
| 47 | 5 | R | |
| 48 | 1 | R | R |
| 49 | 5 | C | |
| 50 | 3 | R | |
| 51 | 2 | R | R |
| 52 | 10 | 1 | |
| 53 | 3 | R | |
| 54 | 2 | R | R |
| 55 | 10 | C | C |
| 56 | 0.5 | R | |
| 57 | 3 | R | R |
| 58 | 5 | C | |
| 59 | 0.5 | | |
| 60 | 5 | C | |
| 61 | 2 | R | |
| 62 | 3 | | |

In the above tables 4-6, C is indicative of “inflating”, R is indicative of “Keep pressure”, and Figure is indicative of “Executing time (Unit: second, under situation column)”.

According to an embodiment, the computing device 106 is directly attached with the massager sleeve 102 to provide flexibility to the user to move while wearing the massager sleeve 102. Further, the compression device can be used to massage either the calf and the knee or the thigh and the knee depending upon the usage. Thus, the compression device provides multifunctionality in using the compression device. In an embodiment, the massager sleeve help the user to recover the muscles, alleviates pain, decrease inflammation, improve blood flow, alleviates foot pain, alleviates chronic pain, combat blood pooling, alleviates restless legs syndrome, alleviates cellulite, alleviates varicosity, trigger points, alleviates soreness, alleviates muscle fatigue, alleviates blood clots, alleviates muscle knots, and alleviates swollen veins. In an embodiment, the compression device helps the user to recover faster after workouts, and the user can relax at the end of a hard day. Further, the massager sleeve of the compression device provides one airbag with two divisions to deliver impressive compression in two zones, a first zone being the knee and a second zone being the calf or thigh, leading to truly therapeutic results.

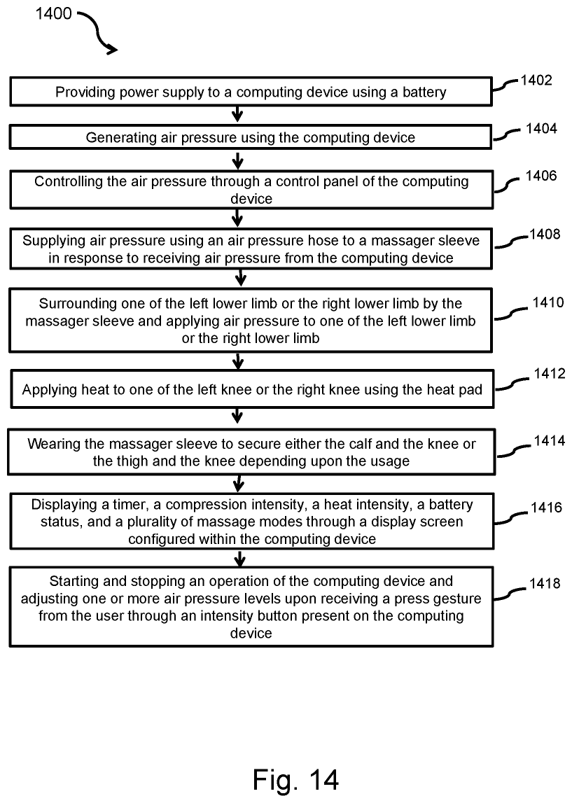

FIG. 14 shows a flowchart 1400 of a method for applying compression on one of a left lower limb or a right lower limb of the user of an embodiment of the present invention. The method includes a step 1402 of providing power supply to a computing device using a battery. The method includes a step 1404 to generating air pressure using the computing device. The method includes a step 1406 of controlling the air pressure through a control panel of the computing device. The method includes a step 1408 of supplying air pressure using an air pressure hose to a massager sleeve in response to receiving air pressure from the computing device. The method includes a step 1410 of surrounding one of the left lower limb or the right lower limb by a massager sleeve and applying air pressure to one of the left lower limb or the right lower limb. The method includes a step 1412 of applying heat to one of the left knee or the right knee using the heat pad. The method comprising a step 1414 of wearing the massager sleeve to secure either the calf and the knee or the thigh and the knee depending upon the usage. The method comprising a step 1416 of displaying a timer, a compression intensity, a heat intensity, a battery status, and a plurality of massage modes through a display screen configured within the computing device. The method includes a step 1418 of starting and stopping an operation of the computing device and adjusting one or more air pressure levels upon receiving a press gesture from the user through an intensity button present on the computing device. In another embodiment, the one or more air pressure levels having a predefined pressure value stored in a memory of the computing device. In another embodiment, the one or more air pressure levels comprises a first air pressure level, a second air pressure level, a third air pressure level, and a fourth air pressure level. In another embodiment, the predefined Pulse Width Modulation (PWM) for the first air pressure level is about 70 percent. In another embodiment, the predefined PWM for the second air pressure level is about 85 percent. In another embodiment, the predefined PWM for the third air pressure level is about 100 percent.

The present invention will now be further exemplified with reference to the following examples. The present invention is in no way limited to the given examples or to the embodiments presented in the figures.

### Example 1

A compression device shown in FIG. 1 is used to deal with tight and sore muscles. The users don't always have a lot of time to sit and soak in a tub. The users just have to strap the sleeves on their legs and let them do the work, while the users get things done on the computer and or catch up on their TV shows. The heat setting feature helps the users from being sore so that the next day the user can go and work out at the highest level they can.

### Example 2

During an experiment, the compression device as shown in FIG. 1 is used by a user to use the compression device while the movement of the user. This feature provides mobility to user while using the compression device provided that the battery of the computing device has been charged properly. The user observes that the compression device is comfortable to put on easy to take off and fits nicely around his wide calves up to his thighs. He wraps it up to his thighs and around his feet then switches the massager on from the handheld control and feels the air circulate. He found the different options for massage levels useful, and he felt the intensity with each mode. It is believed that he found the fabric comfortable and breathable. Additionally, the user can walk in park while using the compression device.

### Example 3

In the experiment of Example 2, it was found that the user used the compression just before bedtime and often fall asleep while it is running. He loves the fact that it automatically shuts off after 30 minutes. The compressions and different settings worked amazingly for him.

### Example 4

In the experiment of Example 2, the user can enjoy the multifunctionality of the compression device. That means, the user can use the compression device on either the thigh and the knee or the calf and the knee depending upon what areas the user want to have massaged today.

It is supposed that the present invention is not restricted to any form of realization described previously and that some modifications can be added to the presented example of fabrication without reappraisal of the appended claims. For example, the present invention has been described as referring to alleviating pain and accelerating recovery, but it is clear that the invention can be applied to heal wounds for instance or to prevent deep vein thrombosis (DVT).

It is clear that the method according to the invention, and its applications, are not limited to the presented examples.

The present invention is in no way limited to the embodiments described in the examples and/or shown in the figures. On the contrary, methods according to the present invention may be realized in many different ways without departing from the scope of the invention.

1. A compression device wearable by a user for applying compression on one of a left lower limb or a right lower limb and applying heat on one of a left knee or a right knee of the user, the compression device comprising:
a massager sleeve adapted to surround one of the left lower limb or the right lower limb, wherein the massager sleeve comprises a first plurality of hook and loop fasteners to secure calf and knee or thigh and knee of one of the left lower limb or the right lower limb of the user, wherein the massager sleeve comprises a heat pad to apply heat to the left knee or the right knee of the user;
a computing device adapted to generate air pressure, wherein the computing device is directly attached to the massager sleeve, and wherein the computing device comprises:
a control panel to control a flow of the air pressure in the massager sleeve; and
a battery to provide power supply to the control panel, wherein the battery is operably connected to the control panel to provide usage of the compression device without being connected with a power supply; and
an air pressure hose to supply air pressure to the massager sleeve in response to receiving air pressure from the computing device, wherein the air pressure hose is directly attached to the massager sleeve to apply the air pressure to one of the left lower limb or the right lower limb.

2. The compression device as claimed in claim 1, wherein the massager sleeve is adapted to secure either the calf and knee or the thigh and knee depending upon usages of the compression device.

3. The compression device as claimed in claim 1, wherein the computing device comprises a display screen to display a timer, a compression intensity, a heat intensity, a battery status, and a plurality of massage modes.

4. The compression device as claimed in claim 3, wherein the battery status indicates a battery level of remaining power available in the battery.

5. The compression device as claimed in claim 1, wherein the computing device comprises a timer button configured to set the timer of usage to the compression device upon receiving a press gesture from the user.

6. The compression device as claimed in claim 1, wherein the computing device comprises an intensity button configured to start and stop an operation of the computing device and to adjust one or more air pressure levels upon receiving a press gesture from the user.

7. The compression device as claimed in claim 1, wherein the computing device comprises a first massage mode button configured to initiate a first command pertaining to simultaneously massage the knee and calf/thigh of the user upon receiving a press gesture from the user.

8. The compression device as claimed in claim 1, wherein the computing device comprises a second massage mode button configured to initiate a second command pertaining to massage at least the calf/thigh of the user upon receiving a press gesture from the user.

9. The compression device as claimed in claim 1, wherein the computing device comprises a third massage mode button configured to initiate a third command pertaining to massage the knee of the user upon receiving a press gesture from the user.

10. The compression device as claimed in claim 1, wherein the computing device comprises a heat mode button configured to initiate a fourth command pertaining to adjusting one or more heating levels.

11. The compression device as claimed in claim 1, wherein the computing device comprises a memory to store a plurality of instructions pertaining to a one or more air pressure levels, a first command, a second command, a third command, a fourth command, and one or more heating levels; and a processor to execute the plurality of instructions stored in the memory.

12. The compression device as claimed in claim 1, wherein the air pressure hose is inserted into the computing device to supply the air pressure, and wherein the computing device is present directly on the massager sleeve.

13. The compression device as claimed in claim 1, further comprising an AC adapter and an extension cord to charge the battery of the computing device.

14. The compression device as claimed in claim 1, wherein the compression devices is configured to be placed in a carry bag when not in use to provide portability.

15. A method for applying compression on one of a left lower limb or a right lower limb and heat on one of a left knee or a right knee of the user, the method comprising:
providing power supply to a computing device using a battery;
generating air pressure using the computing device;
controlling the air pressure through a control panel of the computing device;
supplying air pressure using an air pressure hose to a massager sleeve in response to receiving air pressure from the computing device;
surrounding one of the left lower limb or the right lower limb by the massager sleeve and applying air pressure to one of the left lower limb or the right lower limb, wherein the massager sleeve comprises a heat pad; and
applying heat to one of the left knee or the right knee using the heat pad.

16. The method as claimed in claim 15, further comprising a step of wearing the massager sleeve to secure either the calf and the knee or the thigh and the knee depending upon the usage.

17. The method as claimed in claim 15, further comprising a step of displaying a timer, a compression intensity, a heat intensity, a battery status, and a plurality of massage modes through a display screen configured within the computing device.

18. The method as claimed in claim 17, further comprising a step of starting and stopping an operation of the computing device and adjusting one or more air pressure levels upon receiving a press gesture from the user through an intensity button present on the computing device.

19. The method as claimed in claim 18, wherein the one or more air pressure levels have a predefined pressure value stored in a memory of the computing device.

20. The method as claimed in claim 18, wherein the one or more air pressure levels comprise a first air pressure level, a second air pressure level, and a third air pressure level.

21. The method as claimed in claim 20, wherein a predefined Pulse Width Modulation (PWM) for the first air pressure level is about 70 percent.

22. The method as claimed in claim 20, wherein a predefined PWM for the second air pressure level is about 85 percent.

23. The method as claimed in claim 20, wherein a predefined PWM for the third air pressure level is about 100 percent.

24. The method as claimed in claim 15, further comprising a step of adjusting one or more heating levels through a heat mode button present on the computing device.

25. The method as claimed in claim 24, wherein the one or more heating levels having a predefined heat value stored in the memory of the computing device.

26. The method as claimed in claim 24, wherein the one or more heating levels comprise a first heating level, a second heating level, and a third heating level.

27. The method as claimed in claim 26, wherein the predefined heat value for the first heating level is about 49.7 degrees Celsius.

28. The method as claimed in claim 26, wherein the predefined heat value for the second heating level is about 59.7 degrees Celsius.

29. The method as claimed in claim 26, wherein the predefined heat value for the third heating level is about 60.8 degrees Celsius.

30. The method as claimed in claim 15, further comprising a step of charging the battery using an adapter and an extension cord.

31. The method as claimed in claim 30, further comprising plugging a first end of the adapter into a power outlet and a second end of the adapter into a charging port of the control unit to charge the battery.
